(19) United States
(12) Patent Application Publication
(10) Pub. No.: US 2016/0044910 A1
(43) Pub. Date: Feb. 18, 2016

(54) METHOD AND APPARATUS USING ILLUMINATION SYSTEM FOR ACTIVELY REDUCING THE ENVIRONMENTAL IMPACT OF WIND TURBINE POWER UNITS

(71) Applicants: Tristan Främ Douglas Lang, San Rafael, CA (US); Claire Fridtjof Lang, San Rafael, CA (US); Fred Donald Lang, San Rafael, CA (US)

(72) Inventors: Tristan Främ Douglas Lang, San Rafael, CA (US); Claire Fridtjof Lang, San Rafael, CA (US); Fred Donald Lang, San Rafael, CA (US)

(21) Appl. No.: 14/121,216

(22) Filed: Aug. 12, 2014

(51) Int. Cl. A01M 29/10; A01M 29/08; F21V 7/00; F03D 11/00; F21S 8/00

(52) U.S. Cl. CPC A01M 29/10; F03D 11/0041; F21S 8/00; F21V 7/00; A01M 29/08

(57) ABSTRACT

This invention relates to a method and apparatus comprising an illumination system which produces a light pattern ahead of the turbine blades which disrupts a bird's flight pattern and thus reduces and/or prevents the bird's impact on turbine blades.

### CROSS-REFERENCES TO RELATED APPLICATIONS

This application is related to two other copending applications. All three applications were filed on the same day, Aug. 12, 2014; all three titles are listed below. All applications were invented by the same person; in addition, there are two additional named inventors of the last of the following listed applications.
Apparatus for Diverting Birds from Wind Turbines Using Passive Device;
Method Using Electronic System for Actively Reducing the Environmental Impact of Wind Turbine and Solar Thermal Power Units; and
Method and Apparatus Using Illumination System for Actively Reducing the Environmental Impact of Wind Turbine Power Units

The application numbers of the above were not available at the time of filing. The two copending applications are incorporated herein by reference in their entirety. All of the aforementioned Applications were filed identically except for the Titles, Paragraph [0021_] (e.g., [0021A]), Claims, and the ABSTRACT. The second of the aforementioned Applications includes additional Paragraphs [0002B] and [0003B]. The commonality of this approach was done to ease the examination process as they employ common BACKGROUND, SPECIFICATION and FIGURES sections which use many common features and descriptions, etc. (baring the noted exceptions).

### FIELD OF THE INVENTION

This invention relates to reducing or eliminating harm to birds, when they otherwise would impact wind turbine blades found at wind turbine power units.

### BACKGROUND OF THE INVENTION

Wind turbine power units are commonly used in the United States and throughout the world to off-set electricity generation from fossil-fired power plants. Given the same consumption of electricity by the public, the use of wind turbines obviously reduces global greenhouse gas emissions. However, environmentalists and the general public are increasingly objecting to the destruction of birds when they fly into the rotating blades of wind turbines. In advocating the further use of wind turbine power units, the harm to birds must be reduced. In a very real manner, said reduction would have a positive impact on reducing greenhouse gas emissions, promoting the use of a renewable resource, and would make wind turbines more readily acceptable to the public. No inventor knows of any prior art related to the sustained prevention or sustained reduction of harm to birds caused by rotating wind turbine blades

A 2004 article written by a USDA Wildlife Services employee sates that the typical noise generator, intended to frighten birds, was shown not to have lasting affects unless drastic measures were taken (i.e., killing birds). The reference for this article is: Robert C. Beason, “What Can Birds Hear?”, Proceedings of the 21st Vertebrate Pest Control Conference, RM Timm & WP Gorenzel, Editors, Published at University of California, Davis 2004, pages 92-96. This article does not mention wind turbines; it does not mention solar thermal power plants; it does not mention any other power plant type. The relevance of the article lies only with its assurance that birds learn to ignore noise which being becomes common place to them; unless drastic measures are taken (i.e., killing birds) and when accompanied by an appropriate annoyance. This invention directly addresses this problem.

### SUMMARY OF THE INVENTION

This invention teaches how to reduce the destruction of flying birds caused by power plant units using renewable energy resources; for example such as wind turbines. Three embodiments are presented. The first embodiment is an apparatus which employs a noise-making apparatus placed on one or more turbine blades to frighten birds away from the turbine. Its operation comprises using the air stream relative to the blade, the stream being created when the turbine blade rotates, a noise-making apparatus having an air intake, such as a whistle. Further, the apparatus is so constructed as to produce a variable frequency, varying as a function of both position on the turbine blade, its rotational speed, and the angle of attack relative to the wind velocity. The noise-making apparatus's outlet is directed ahead of the turbine to frighten birds. Note that as the local wind changes velocity the noise-making apparatus is designed to change frequency. The advantage of this embodiment is that it is passive: as the blade turns a noise is produced.

A second embodiment is a method comprising an active electronic system in which sonic, ultrasonic or radar waves are used to detect, then frighten away, one or more in-coming birds whose un-interrupted path would otherwise intersect with dangers associated with power plant units using renewable energy resources (i.e., blades on a wind turbine power plant unit, or the high energy flux produced at a solar thermal power plant unit). The said in-coming birds are “targets” to the electronic system. The target's course and speed would be identified, and action taken to divert paths. The action taken comprises directing noise or lights aimed at the targets to thus frighten them away from the power unit. The advantage of this embodiment is that it would only produce diverting noise or light signals when targets are identified, thus the produced noise and/or light image would have minimum impact on the local populace, they being used only intermediately. When applied at a wind turbine power unit, it is a system which does not interface with the blades proper. The apparatus is mounted near the central hub of the wind turbine, or near the solar flux, both in a static manner. For a wind turbine power unit, the “central hub” is sometimes referred to as the machine's nacelle. Given that functioning equipment associated with the power units is not impacted, the system is easily retro-fitted to existing wind turbine or solar thermal power units.

A third embodiment comprises a method and apparatus of an illumination system applicable to wind turbine power units. This system comprises of light sources which are directed to mirrors mounted near the ends of turbine blades with the result of creating various patterns of light visible ahead of the turbine. Such patterns of light are chosen to frighten birds away from the blades. Each blade has a unique source of light, said light source is mounted on the turbine's rotating hub. The emitted light would be reflected through mirrors to a point(s) ahead of the turbine. The resultant light pattern may remain static in the axial plan, presenting only rotating rays from each blade. If the light pattern is not visible enough to birds, a mist of water may be injected into the illuminated space thus accenting the light by diffusion. The advantage of an illumination system is that it makes no noise and may be turned on only when targets present themselves, thus reducing light pollution.

### BRIEF DESCRIPTION OF THE DRAWINGS

FIG. 1 illustrates the system comprising of a whistle mounted on a turbine blade.

FIG. 2 illustrates the electronic system of diverting birds from wind turbine blades.

FIG. 3A illustrates the general layout of the illumination system of diverting birds from turbine blades.

FIG. 3B details the illumination system as to how sourced light rays are reflected at a hub mirror, to a fixed blade mirror and then to ahead of the turbine to thus achieve the objective of the invention, the diverting of a bird's flight path.

### DESCRIPTION OF THE PREFERRED EMBODIMENT

Teaching the implementations of the present invention is presented as one of three embodiments, all of which are discussed in the following paragraphs. Paragraph [0021] identifies the claimed Preferred Embodiment. The first embodiment, although simple to install, represents a ready solution, and an inexpensive solution, to the problem of birds flying into turbine blades associated with a wind turbine power unit. This embodiment is a noise-making apparatus mounted on the blade whose intake is derived from the air stream created when a turbine blade rotates. Its intake is parallel to the air's direction relative to its placement on the blade. For example if the noise-making apparatus is mounted on the blade's tip, it maybe mounted at an angle relative to the cord of the blade to achieve parallel flow with the air's flow as it is shed from the blade's tip. If mounted on the leading edge of the blade, the noise-making apparatus can be directed at an angle from the rotating axis such that the relative air velocity impacts the noise-making's intake as a parallel flow for maximum effect. Thus such mounting alters the noise-making apparatus's angle of attack relative to the wind velocity. The outlet horn of the noise-making apparatus is directed towards the front of the turbine; i.e., towards the bird's potential flight path. In general, noise-making apparatus of this embodiment consist of mechanical devices without moving parts other than a possible reed. Noise-making apparatus of this embodiment comprise: whistles, devices using reeds, devices using various lengths and sizes of outlet horns, and similar devices.

Since birds may become accustomed to certain frequencies, the noise-making apparatus and blade configuration of the first embodiment has an ability to produce various frequencies while remaining a passive device. This is intrinsically accomplished given that wind turbines often rotate at varying speeds and at different angles of attack relative to the wind velocity. Thus when a turbine encounters s variable wind velocity, the noise-making apparatus as attached to each blade produces variable frequencies.

The second embodiment comprises a method for producing a wave form (e.g., sonic, ultrasonic, radar waves, or like waves), a computer used to analyze return signals from said waves, and a method of activating an annoyance noise directed towards the birds which frightens birds thus diverting their course away from a power plant unit using renewable energy resources. As targets of the said waves, a bird or flock approaching the power plant unit, is detected via return waves as to the target's course and speed. Such technology is considered well established and known to one skilled in the art; it has been practiced and improved since the 1940s. The computer would analyze the input signals based on programming then make a decision as to potential collision with the power plant unit, and, if so, produce an output signal which would actuate a disruptive noise and/or light images which would frighten birds away from the power unit.

In addition, for the second embodiment, the computer may determine the most likely method to use for redirecting the bird or flock based on detected size, speed and/or flight pattern. The computer may have a data storage mechanism which aids in determining which disruption is best suited to frighten a given type of bird. Such data storage may be a function of bird size, type and/or flight formation patterns; e.g., geese tend to fly in “V” formations, ducks fly faster than geese, etc. The computer may also have the ability to decide if the action which was taken was successful, if not, then additional measures could be activated. It is a system which would not interface with any component associated with the power plant unit; it would be mounted in front of the power unit. The second embodiment has no moving parts. Given such static placement the system could be retro-fitted to existing power plant units.

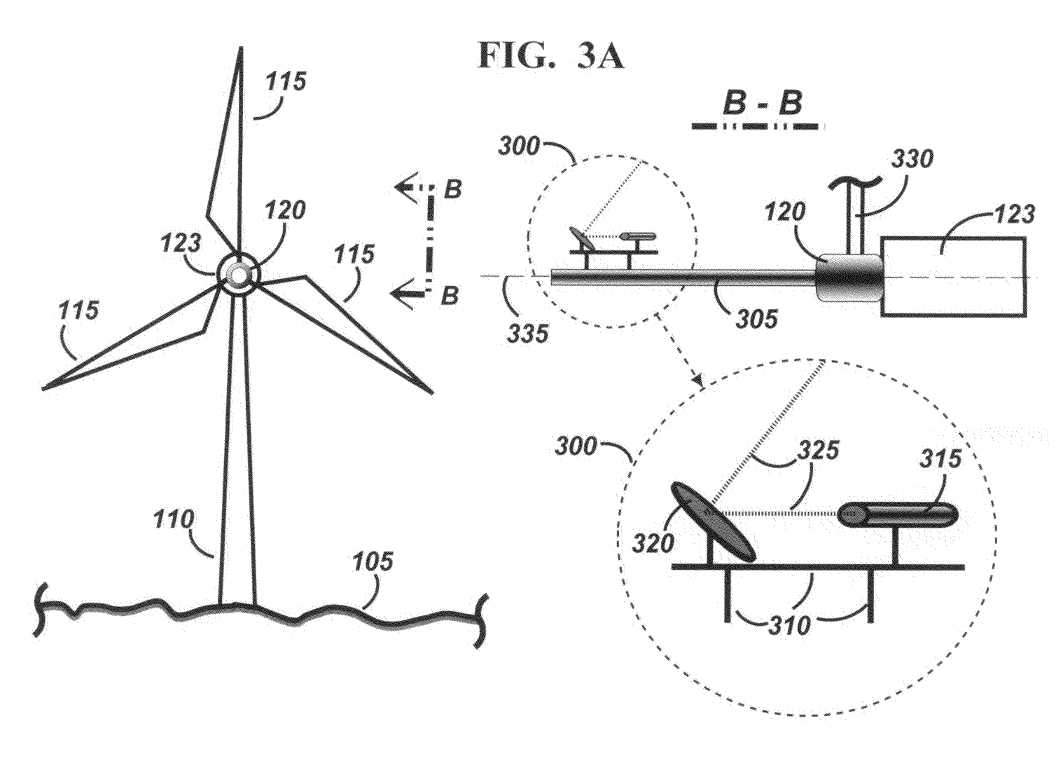

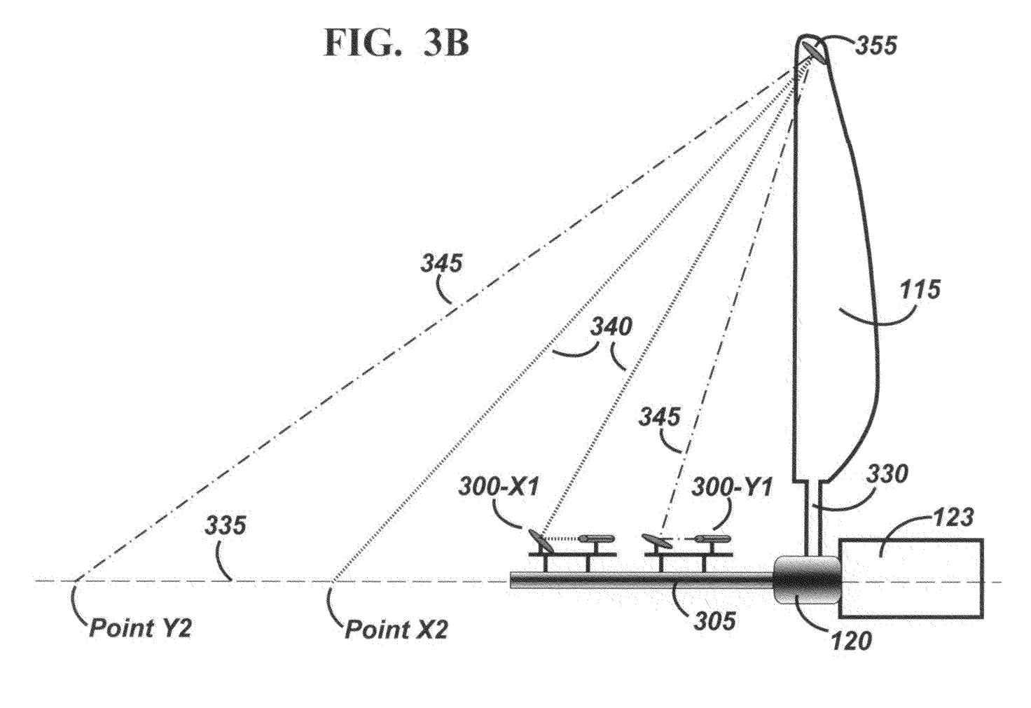

The third embodiment is a method and apparatus comprising an illumination system which produces a light pattern ahead of the blades of a wind turbine power plant unit which disrupts a bird's flight pattern and thus reduces and/or prevents blade impact. This illumination system comprise a light source which is attached to the central hub (nose) of the wind turbine producing a light which is directed to a mirror also attached to the central hub. This mirror is termed the “hub mirror”. For every turbine blade there is a light source and hub mirror; the light source and hub mirror rotate in unison with each turbine blade. The light source and hub mirror combination are herein termed a “light sub-assembly” (the light source and hub mirror combination is detailed in FIG. 3B as feature 300, and as further described below). As discussed below the light sub-assembly may only employ a light source). As described by feature 300, the light source directs its beam to the hub mirror, which in turn reflects its incoming light to a mirror mounted near the tip the blade; this mirror is termed the “fixed blade mirror”.

The fixed blade mirror of the third embodiment is positioned in a fixed manner relative to the blade. From the fixed blade mirror, the light then is reflected ahead of the turbine (e.g., to the vertex of a cone of light). The light source comprises a laser, or light in the visible spectrum, or a strobe light, or a source having similar functionality, or use of the sun's light. The fixed blade mirror has a fixed position on the blade to reduce the cost of blade manufacture, to eliminate the need for re-alignment or movement mechanisms. The hub mirror may be in a stationary position, both axially and rotationally. The hub mirror (or the entire light sub-assembly) may also move in the axial direction, that is closer or nearer to the turbine blade; if so moved, to then maintain light ray alignment with the fixed blade mirror, the hub mirror must be allowed to rotate (see FIG. 3B). If adjustable, the light sub-assembly may move based on the data collected from observations or sonic, ultrasonic or radar detectors. Once a given light pattern is established, the light sub-assemblies could remain static, or be placed in an automatic operation. The hub mirrors could also be designed to reflect sunlight. The pattern of light is typically a cone shape whose vertex is ahead of the turbine, the vertex found on the turbine's axis of rotation. As the turbine rotates, its light pattern rotates forming a visual pattern (e.g., a cone shape), to be avoided by birds. If a laser is used, or the local environment is dry with little water vapor to disperse light, then the system may be sprayed with a water mist thus creating a light dispersing medium resulting in making the light visible from any direction.

Further, the illumination system of the third embodiment may comprise a system in which all light sub-assemblies move in unison: back and forth relative to the turbine blade, but maintaining the same aiming points on the fixed blade mirrors. This requires the hub mirror (or light source) to tilt such that the fixed blade mirror is always hit with a ray from the light sub-assembly. This variation allows, for example, if the light shape is a solid cone, for the cone's vertex to move back and forth. As the light sub-assemblies are moved closer to the turbine blade, the cone's vertex moves away from the turbine. This action creates an image of an oscillating cone.

The third embodiment's use of a light sub-assembly, as described in the above paragraphs, also includes a light source aimed directly towards the fixed blade mirror. This variation thus eliminates the hub mirror, but also means that the light source, to maintain light ray alignment with the fixed blade mirror, must be allowed to rotate in a manner similar to that required if using a hub mirror (see FIG. 3B features 300-X1 versus 300-Y1 as an example of a tiling hub mirror).

Further still, the illumination system of the third embodiment may comprise fixed light sub-assemblies, but for each blade the light sub-assemblies are fixed at different, staggered positions. Such staggered positioning will create a screw-like image ahead of the turbine which appears to rotate—a rotating screw. The advantage of this refinement is that, after alignment, it requires no moving parts, other than the moving turbine blades and each of their attached, and fixed, light sub-assemblies. As being moved with the rotational speed of the turbine, and especially if more than three blades are being used, this refinement results in an oscillatory rotating screw-like image which would scare a pterodactyl.

In summary, the Preferred Embodiment submitted for these inventions is the third embodiment which is herein claimed in CLAIMS and describes a method and apparatus comprising an illumination system which produces a light pattern ahead of the turbine blades which disrupts a bird's flight pattern and thus reduces and/or prevents blade impact. This third and the Preferred Embodiment comprises:
A method for reducing harm to a flying bird if otherwise impacting a turbine blade of a wind turbine power plant unit, the wind turbine comprising a group of rotating turbine blades, said turbine blades affixed to a central hub, the rotating system of the turbine blades and the central hub generating electric power, the method comprising the steps of determining an illuminated image which is an annoyance to the flying bird resulting in the flying bird altering its direction away from the illuminated image;
causing a set of light rays generated from a set of light sub-assemblies mounted on the central hub, one light sub-assembly aligned with each turbine blade, resulting in a set of light sub-assemblies emitting the set of light rays;
aiming the set of light rays emitted from the set of light sub-assemblies to a set of fixed blade mirrors mounted on the turbine blades, whose reflected light rays are then directed ahead of the wind turbine power plant unit, resulting in a set of aimed light emitting turbine blades; operating the set of aimed light emitting turbine blades such that the illuminated image which is the annoyance to the flying bird is produced ahead of the wind turbine power plant unit thus reducing harm to the flying bird, based on the illuminated image which is the annoyance, the set of light sub-assemblies emitting the set of light rays, and the set of aimed light emitting turbine blades.
Also, regards the method mentioned above, the step of causing the set of light rays, includes light rays selected from a group of light rays comprising laser light, light frequencies in the visual spectrum and sun light, said set of light rays generated from a set of light sub-assemblies mounted on the central hub, one light sub-assembly aligned with each turbine blade, resulting in a set of light sub-assemblies emitting the set of light rays.
Also, further, regards the method mentioned above, the step of determining the illuminated image which is the annoyance to the flying bird, includes the step of:
determining an animated illuminated image which appears to have visual motion, which is an annoyance to the flying bird resulting in the flying bird altering its direction away from the illuminated image.
An apparatus for reducing harm to a flying bird if otherwise impacting a turbine blade of a wind turbine power plant unit, the wind turbine comprising a group of rotating turbine blades, said turbine blades affixed to a central hub, the rotating system of the turbine blades and the central hub generating electric power, the apparatus comprising:
means of identifying an illuminated image which is an annoyance to the flying bird resulting in the flying bird altering its direction away from the illuminated image;
a set of light sub-assemblies mounted on the central hub, one light sub-assembly producing a light beam aligned with each turbine blade, resulting in a set of light sub-assemblies emitting a set of light beams;
means of aiming the set of light beams emitting from the set of light sub-assemblies to a set of fixed blade mirrors mounted on the turbine blades, one light sub-assembly and its light beam aligned with each turbine blade, resulting in a set of reflected light beams directed ahead of the turbine;
means of forming the illuminated image by adjusting the set of reflected light beams directed ahead of the turbine, resulting in an illuminated image ahead of the wind turbine power plant; operating the group of rotating turbine blades with the illuminated image ahead of the wind turbine power plant thus causing visual motion to the illuminated image thereby reducing harm to a flying bird by altering its direction away from the illuminated image.
Also, regards the apparatus method mentioned above, the set of light sub-assemblies mounted on the central hub includes a laser beam, a light beam having a frequency in the visual spectrum, and a sun beam.
Also, further, regards the apparatus method mentioned above, the means of identifying an illuminated image includes identifying an animated illuminated image which appears to have visual motion.

### THE DRAWINGS

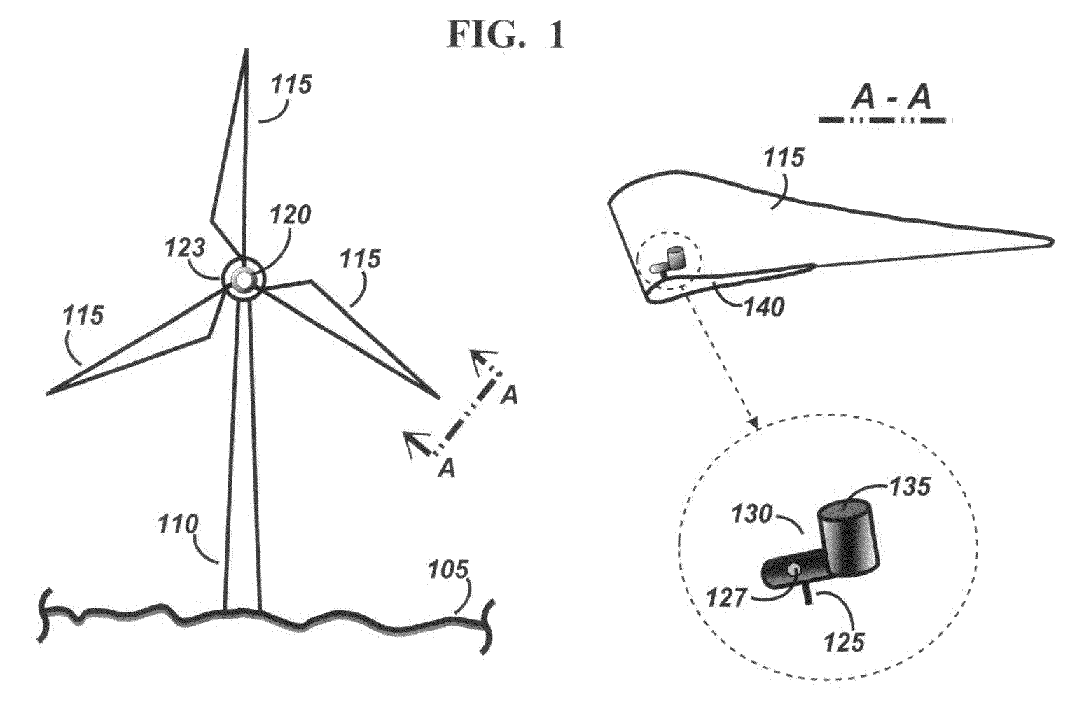

FIG. 1 represents the first embodiment comprising a noise-making apparatus mounted on the blade of a wind turbine. A wind turbine is generally described by FIG. 1. However, in detail, as illustrated by example in FIG. 1 is a whistle noise-making device. In FIG. 1 feature 105 is the ground. Feature 110 is the support structure for the wind turbine whose generator is 123. 115 are turbine blades; note they can be of any design. Feature 120 is the turbine's central hub to which are attached turbine blades 115; this assembly of central hub 120 and blades 115 rotate together; and for this example, rotate in a clockwise direction. The hub's axis is connected to the generator's 123 armature; when the blades are moved by the wind, the hub turns the armature, thereby making electricity. For FIG. 1, the wind's direction is into the paper. Note that cut-away section A-A is viewing a typical blade edge-on; the end of the turbine blade is feature 140 showing typical blade twist and taper. Feature 130 is a whistle mounted on 115 whose intake is directed towards the highest wind direction relative and local to the blade. Every blade 115 has a 130 whistle. Feature 127 is a tuning hole placed on 130 to achieve the desired frequency. Feature 135 is the outlet from the whistle which is pointed out of the paper into the wind, towards any bird's potential flight path. Feature 125 is a support structure for 130 which maybe adjusted to achieve the desired effect; i.e., the highest noise for an average turbine rotational speed.

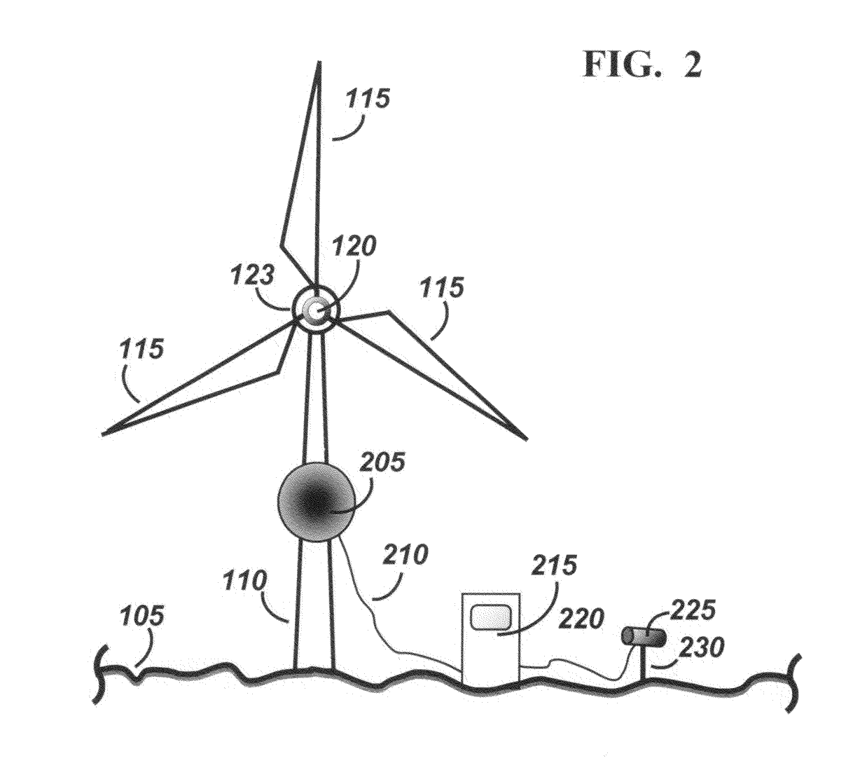

FIG. 2 represents the second embodiment comprising a method for producing sonic, ultrasonic or radar waves, a computer used to analyze return signals from the targets of said waves, and a method of activating a warning signal which frightens birds away from a wind turbine. A wind turbine is generally described by FIG. 2. Within FIG. 2 the features described as 105, 110, 115, 120 and 123 are the same features as described in FIG. 1. Feature 205 is a device for producing sonic, ultrasonic or radar waves. The input and output signals 210 associated with 205 are produced and analyzed by a computer 215. Based on the danger of harming birds, the computer 215 produces a signal 220 which activates a noise-making or light-making device 225. Feature 225 is directed out of the paper into the wind, towards any bird's potential flight path. Feature 230 is the support structure for 225.

FIG. 2 also describes the essential features when the second embodiment is applied at a solar thermal power unit. The high energy flux simply replaces FIG. 2's wind turbine features 110 through 123.

FIG. 3A represents an overview of the third embodiment comprising a method and apparatus for an illumination system. A wind turbine is generally described by FIG. 3A. Within FIG. 3A the features described as 105, 110, 115, 120 and 123 are the same features as described in FIG. 1 and in FIG. 2. Section B-B is side view of the turbine's hub region. Feature 330 is the lower portion of the turbine blade 115 as it interfaces with the central hub 120. Note that in section B-B only one turbine blade (and only its lower portion), and associated light source and hub mirror are shown for clarity. 305 is a shaft extending from the central hub 120, used to support the light source 315 and the hub mirror 320. Feature 335 is indicating the centerline of the turbine axis. Features indicated by 310 are support structures which allow axial movement. The light source 315 produces a light ray 325 which is directed to the hub mirror 320, which is then reflected by 320 to the fixed blade mirror (not shown in FIG. 3A). The entire assembly of light source 315, hub mirror 320 and supports 310, is termed the “light sub-assembly”, feature 300.

FIG. 3B represents the optical details of the third embodiment comprising a method and apparatus for an illumination system. FIG. 3B is illustrating view B-B of FIG. 3A, viewing the hub and its turbine blade from their sides. Within FIG. 3B the features described as 120 and 123 are the same features as described in FIG. 1. Within FIG. 3B the features described as 300 (the light sub-assembly), 305, 330 and 335 are the same features as described in FIG. 3A. Feature 115 is the turbine blade viewed from its side, indicating twist and taper. Mounted near the end of 115, near the blade's tip, is a mirror 355 placed in a fixed position such that its incoming ray is directed to a point ahead of the wind turbine. Feature 355 is termed “a fixed blade mirror”. The optics of the third embodiment results in a light ray 340 generated from light sub-assembly 300 when it is positioned at X1, the light from 300-X1 being aimed at the fixed blade mirror 355, it then being reflected from 355 to a point ahead of the wind turbine intersecting the axis 335 at point X2. Therefore, it is then seen that if the light sub-assemblies 300 are mounted in the same axial position, say at an X1, one for each blade, and rotated with the blades, then an image of a cone of light will be created with a single vertex intersecting 335 at X2. If however, the light sub-assembly 300 is moved to a new position Y1, and given that the fixed blade mirror 355 has a fixed position, its light ray 345 from 300-Y1 will intersect axis 335 at a point Y2. Note that the hub mirror at 300-Y1 has tilted such that 355 is in alignment. Therefore, it is seen that by placing light sub-assemblies 300 at different axial positions (X1, Y1, etc.) that the light rays will intersect axis 335 at different points (X2, Y2, etc.).

Further, for the third embodiment, if the light sub-assemblies 300 are mounted in a staggered and uniformly spaced fashion along 305 (i.e., along the axial direction), one placement for each blade, fixed in place, and rotated with the blades, then a screw-like visual projection will result ahead of the wind turbine. Although certainly not required, use of uniformly spaced light sub-assemblies 300 in the axial direction results in a variable “thread pitch” for the projected screw, adding visual confusion. Further, this refinement demonstrates that by allowing movement in the axial direction of one or more light sub-assemblies 300, coupled with appropriate timing of said movement, that essentially any three-dimensional image could be created which would visually appear to rotate, or not rotate, about 335. Such images could include a predator bird with moving winds; such an image could be accompanied by hunting sounds of a predator if more efficient at frightening birds away from the wind turbine.

FIG. 3A and FIG. 3B of the third embodiment also aids in defining “a light emitting turbine blade”, herein defined as feature 300 coupled with the attached turbine blade 115 which has the fixed blade mirror 355. The light emitting turbine blade rotating with the central hub 120. Typically a light emitting turbine blade will be installed for each turbine blade designed for the wind turbine power plant unit; a three bladed turbine as seen in FIG. 3A will use three light emitting turbine blades.

What is claimed is:

1. A method for reducing harm to a flying bird if otherwise impacting a turbine blade of a wind turbine power plant unit, the wind turbine comprising a group of rotating turbine blades, said turbine blades affixed to a central hub, the rotating system of the turbine blades and the central hub generating electric power, the method comprising the steps of
determining an illuminated image which is an annoyance to the flying bird resulting in the flying bird altering its direction away from the illuminated image;
causing a set of light rays generated from a set of light sub-assemblies mounted on the central hub, one light sub-assembly aligned with each turbine blade, resulting in a set of light sub-assemblies emitting the set of light rays;
aiming the set of light rays emitted from the set of light sub-assemblies to a set of fixed blade mirrors mounted on the turbine blades, whose reflected light rays are then directed ahead of the wind turbine power plant unit, resulting in a set of aimed light emitting turbine blades;
operating the set of aimed light emitting turbine blades such that the illuminated image which is the annoyance to the flying bird is produced ahead of the wind turbine power plant unit thus reducing harm to the flying bird, based on the illuminated image which is the annoyance, the set of light sub-assemblies emitting the set of light rays, and the set of aimed light emitting turbine blades.

2. The method of claim 1, wherein the step of causing the set of light rays, includes light rays selected from a group of light rays comprising laser light, light frequencies in the visual spectrum and sun light, said set of light rays generated from a set of light sub-assemblies mounted on the central hub, one light sub-assembly aligned with each turbine blade, resulting in a set of light sub-assemblies emitting the set of light rays.

3. The method of claim 1, wherein the step of determining the illuminated image which is the annoyance to the flying bird, includes the step of:
determining an animated illuminated image which appears to have visual motion, which is an annoyance to the flying bird resulting in the flying bird altering its direction away from the illuminated image.

4. An apparatus for reducing harm to a flying bird if otherwise impacting a turbine blade of a wind turbine power plant unit, the wind turbine comprising a group of rotating turbine blades, said turbine blades affixed to a central hub, the rotating system of the turbine blades and the central hub generating electric power, the apparatus comprising:
means of identifying an illuminated image which is an annoyance to the flying bird resulting in the flying bird altering its direction away from the illuminated image;
a set of light sub-assemblies mounted on the central hub, one light sub-assembly producing a light beam aligned with each turbine blade, resulting in a set of light sub-assemblies emitting a set of light beams;
means of aiming the set of light beams emitting from the set of light sub-assemblies to a set of fixed blade mirrors mounted on the turbine blades, one light sub-assembly and its light beam aligned with each turbine blade, resulting in a set of reflected light beams directed ahead of the turbine;
means of forming the illuminated image by adjusting the set of reflected light beams directed ahead of the turbine, resulting in an illuminated image ahead of the wind turbine power plant;
operating the group of rotating turbine blades with the illuminated image ahead of the wind turbine power plant thus causing visual motion to the illuminated image thereby reducing harm to a flying bird by altering its direction away from the illuminated image.

5. The apparatus of claim 4 wherein the set of light sub-assemblies mounted on the central hub includes a laser beam, a light beam having a frequency in the visual spectrum, and a sun beam.

6. The apparatus of claim 4 wherein the means of identifying an illuminated image includes identifying an animated illuminated image which appears to have visual motion.
